(19) United States
(12) Patent Application Publication
(10) Pub. No.: US 2007/0044383 A1
(43) Pub. Date: Mar. 1, 2007

(54) Magnetically assisted HVAC door sealing

(75) Inventor: Steven B. Marshall, Oxford, MI (US)

Correspondence Address: Valeo Climate Control Corp.;Intellectual Property Department, 4100 North Atlantic Boulevard, Auburn Hills, MI, 48326, US

(73) Assignee: Valeo Climate Control Corp., Auburn Hills, MI (US)

(21) Appl. No.: 11/217,701

(22) Filed: Aug. 31, 2005

(51) Int. Cl. E06B 7/16

(52) U.S. Cl. 49/478.1

(57) ABSTRACT

The present invention, in various aspects, provides for a HVAC unit having at least one door and at least one part of an HVAC housing, such that the housing and door can approach one another and form a seal. Preferred embodiments of the present invention use a magnetically assisted (or resistant) door sealing mechanism to form a seal, or preferably, a tight seal, upon closure at a sealing area having a door sealing surface and a corresponding HVAC housing or other such surface, which blocks or restricts air flow in that area of the HVAC unit. By using a magnetically assisted door sealing mechanism, and, especially a mechanism at a sealing surface and a corresponding surface, a seal, and even an almost air tight seal that is resistant to opening inappropriately when air flow or pressure increases or when influenced by gravity, and can be formed while still allowing for the door to be opened, with a minimum of effort, when necessary.

### FIELD OF THE INVENTION

The present invention relates to HVAC units, and, in particular, HVAC units having doors with seals.

### BACKGROUND OF THE INVENTION

HVAC units traditionally use door (or flap) and seals at the area of contact of the door or flap and other parts of the HVAC units, and, in particular, automotive HVAC units. Sealings often come in three principle forms; foam edge strip sealing, fully covered door foam sealing and ‘Santoprene’ or rubberized over-molding. Each of these sealing forms is an attempt to remove the negative effects of part production tolerance found in HVAC building processes. When a door is molded it cannot be molded ‘exactly’ as a drawing or design would indicate; it is inevitable that some form of twist, warp, pseudo-parallelism or displacement of sealing surfaces or edges will occur. Hence, the surfaces or edges of the contact areas (the lines of contact) of door and unit must be compliant (or flexible) where air needs to be sealed/diverted from one stream to another, such as to prevent inappropriate air leakage or bypass in or through the sealing region.

Compliance in the foam or rubber type material has been used to allow a certain flexure at the surfaces or line of contact of the surfaces and to close up the air leakage paths. Low stiffness or compliance may be seen along the door/flap to HVAC walls sealing surface. This stiffness is low in comparison to the base material of which the door or opposing sealing plane/surface/edge is made. Normally, though low stiffness at the sealing surfaces is desired, the stiffness is still appreciable at the time of sealing of HVAC doors to the HVAC inner walls, especially through the moment arm or torque of the door as it turns to close, and then seal, at the lines of contact. When foam, Santoprene or other material is compressed, actuation or compression force or torque increases dramatically. This steep change in actuation effort usually means that units require a cam or some form of mechanical system to overcome the increased torque, and the forces of the door closure must be amalgamated or integrated with the actuator or mechanical control head. The steep increase in the force or torque of closure is further accentuated by gravitation forces, aerodynamic forces and bearing friction forces. In addition, foam compression, when coupled with the gravitational forces on the door, lead to a compounded torque/force steep in slope and large in magnitude. The combination of these forces means that prior art door closure mechanics have a profile near or surpassing the acceptable level reliable force/torque profile. The result can be leaky doors, undesired heat pickup, and the disadvantages of whistle noises, misting glass, and, for those in the passenger compartment, dry eyes due to inappropriate air passage or conditions and an overall more poorly functioning HVAC unit. The end result has been the need for more stringent specifications and more costly actuator or kinematics designs or packages.

### SUMMARY OF THE PRESENT INVENTION

The present invention, in preferred embodiments uses a magnetically assisted (or resistant) door sealing mechanism to form a tight seal upon closure at the area of a sealing surface when a flap or door (collectively, doors) of an HVAC unit is in a closed (air blocking or resistant to air flow) position. By tight seal, it is meant a seal formed by surfaces, and, especially a sealing surface and a corresponding surface, in a region that has a sealing area with a sealing surface and corresponding surface, particularly along a sealing plane, that is resistant to opening inappropriately when air flow or pressure increases or when influenced by gravity, as well as a seal which is almost air tight while still allowing for a door to to be opened, with a minimum of effort, when necessary, preferably by action of opening kinematics or an actuator or actuators. By sealing plane it is meant a preferably planar line or surface, where a door and HVAC contact to seal. A magnetically assisted door sealing mechanism can be seen as another means of aiding natural forces in HVAC door to HVAC wall sealing applications. For example, where a gravitational component on a barrel type door is strong, and the door needs to seal ‘upwards’ or against the direction of a gravitational pull, aspects of the present invention provide for attractive forces (the attractive magnetic sealing force of a magnetically assisted door sealing mechanism) arranged in a manner to overcome the gravitational force component of the door opening force, corresponding sealing surfaces at the point or line of contact (sealing plane) or sealing of the door and another part of the HVAC unit, when in an upper closing position. The door seals tight (tight seal) by using a door sealing mechanism, an in particular a magnetically assisted door sealing mechanism, comprising at least one magnetic closure. In aspects of the present invention, use of such a magnetic closure reduces or eliminates the compression required to form a tight seal.

In preferred embodiments of the present invention, at least one HVAC door, and preferably, two or more or a plurality of doors with sealing planes and surfaces (sealing surfaces) can have magnetically impregnated materials (material impregnated with magnetically charged elements, such as magnets or the like) to assist or resist in the door sealing process/action.

A sealing area is an area where a plane or surface (sealing surface) related to or part of a the door, and a corresponding surface of another part of the HVAC unit, (such as a part of the HVAC wall, casing, tower, ledge, or edge), come together to form a seal. Aspects of the present invention provide for at least one magnetic closure located in or on a sealing surface or a corresponding surface. Alternatively or additionally, at least one magnetic closure may be located in or near both the sealing surface and the corresponding surface.

In another aspect of the present invention, when a door or flap closes forcefully or ‘slams’ due to, for example, aerodynamic momentum, gravitational forces or door inertia/polar inertia point of view, a magnetically assisted door sealing mechanism comprising at least one magnetic closure, uses a repulsive form of magnetic closure, that softens or slightly repels the door just prior to its closure and still allows for a tight seal. A magnetic closure, for example, having two or more magnetized elements (magnets), orients repelling magnets, (e.g. north repels north, and south repels south). The attraction comes from N<>S and S<>N attraction, only after a kinematic movement of the door allows polar alignment and opposing misalignment to occur. Therefore, the magnetic closure has magnetized elements which lightly repel one another before attracting each other and causing the door sealing surface and corresponding surface to seal tight (tight seal) or become completely shut. The ‘repulsion’ or ‘resistance’ is greatest as the sealing faces come closer to one another, and is overcome as the kinematic displacement acts.

Aspects of the new invention here present utilize a form of magnetic ‘preloading’ adapted to each case, to absolve any untoward gravitational, frictional, inertial or aerodynamic force working against adequate closure. The magnetic force of such a system need only act over a few millimeters along the magnetic vector in the local region, whether it be via repulsive or attractive magnetic related forces. The magnetic field strength in the local region increases rapidly to overcome the aforementioned forces, either individually or grouped. In preferred embodiments of the present invention, the magnetic closure comprises magnetic materials embedded, impregnated or otherwise placed within the HVAC sealing region. Magnetic materials are preferably molded or bonded into or on the corresponding surface, and, in various aspects, the materials forming the magnetic or magnetized element are therefore ‘linked’ with a surface that comes together with another corresponding sealing surface or surfaces at a sealing plane or planes. The magnetic closure may be of one or many parts and be in or along one or more surfaces of either the door or flap of the HVAC unit.

In preferred aspects of the present invention, the HVAC doors, when sealing tightly closed at the area of the sealing surface, reallocate the forces needed to seal the door, for example, to the HVAC case by utilizing magnetism provided by a magnetic means or mechanism. By reducing or increasing the door/HVAC unit related forces/torque, as appropriate, at the actuator or actuation control mechanism (control head), aspects of the present invention allow for tight seals while allowing for smooth opening or breaking of the seal where appropriate. The overall advantage of the use of such a magnetic sealing means is a reduction in actuator and/or actuation cost related to door sealing in the HVAC unit.

The present invention in various aspects, uses ‘magnetic’ type of seal or seals at the sealing area, particularly at the sealing surface of a door formed at the area, with the corresponding surfaces of others parts of an HVAC unit. It has been found that use of a ‘magnetic’ type of seal reduces specific spikes in actuation force or torque profiles throughout the mode or blend or recirculation actuation of the HVAC, especially in the HVAC units that use foam or rubber compression in door sealing. Thus, positively augmenting the natural forces in the door closing force or torque profile using magnetic fields. The sealing function interrupts air flow between areas in the HVAC.

Magnetic materials may be found in a base of foam, overmould, plastic, Santoprene, or the like base, in HVAC cases or ‘housing’ walls, tower features, ledges, edges or features related to sealing the doors/flaps of the HVAC.

Door, as is understood in the present invention, can be any sort of door or flap useful in HVAC units, and, in particular, automotive HVAC units where a tight seal that prevents conditioned air from going from one region to another region is desired. Non-limiting examples include doors wherein tight seals are formed such as: butterfly door types, both symmetrical and asymmetrical; flag door types, straight and/or curved doors; barrel door type doors and; sliding louvers type doors.

In aspects of the present invention, the magnetic sealing means can be used, with or without use of a compressible foam or rubber seal at the sealing or corresponding surface to react to or absorb any door to casing intolerance due to manufacture of a design which needs to allow for or absorb such tolerances. The sealing or corresponding surfaces, in aspects of the present invention, are magnetically attracted (preferred) to one another over a short range. This attraction can be in contrast to, or in substitution for, a repulsion only effect such as that found where foam without magnetic sealing means is present. The attraction effect eliminates or reduces the load, force or torque effort required in order to seal or close the door or flap. The door can now be of a compliant or not-so stiff design, as rigidity of the door is not needed to support the torque and shearing stresses of non-uniform pressure generated by use only foam seal sealing.

Preferred aspects of the present invention, by using magnetism, provide for more favorable actuation or actuator efforts, forces or torques, particularly in the final or last stages of opening or closing a door or flap, especially just before tight sealing. Cost savings are provided as separation of door and corresponding surfaces from their tight seal condition takes less effort and low power actuators, and/or the actuator count (number of actuators) can be reduced. In addition, fewer and less complicated cam tracks and mechanical parts are necessary for doors utilizing the aspects of the present invention, as for example, cam tracks can be made less steep to reduce actuation torque, reducing final closing torque and or holding torque.

The present invention also provides for preferred aspects wherein the tight seal allows for a generally hermetically sealed door, as the doors are automatically pulled or attracted to their respective sealing planes.

Aspects of the present invention also allow for a door that does not have to be structurally substantial or ‘strong’. By providing for a simpler or more effective system utilizing magnetism, door strength or stiffness/compliance is more easily designed.

In preferred aspects of the present invention, the level of door sealing can be adjusted or selected depending of the need for a more or less hermetic seal. In preferred embodiments of the present invention, by selecting polar orientation or displacement of the magnetically affected surfaces, the amount of door sealing is tuned by adjusting repulsion and or attraction aspects.

Preferred are aspects where the door with magnetic mechanism utilize undulations, and preferable, micro-undulations, with a north/south polarity, in base material comprising a generic closure. In aspects wherein micro-undulations are fixedly placed or integrated in opposing seals, it is possible to magnetically ‘cam out’ or ‘lever’ the attraction, by forcing the seals to slide so their N<>S and S<>N attractions become N<>N and S<>S repulsions. This allows for increased facility or ease of opening the magnetically closed seal.

### BRIEF DESCRIPTION OF THE DRAWINGS

FIG. 1 illustrates present art barrel door, where gravity torque and foam compression torque gives a ‘large’ resultant torque seen by the actuator.

FIG. 2 illustrates an aspect of the present invention with barrel door, with gravity torque and the attraction of the magnetic sealing torque gives a ‘smaller’ resultant torque seen by the actuator.

FIG. 3 illustrates present art louver door, showing the upper surface bowing/bending when the foam is compressed.

FIG. 4 illustrates an aspect of invention with louver door type, showing the foam compression is overcome/counteracted by the magnetic attraction forces between the two sealing surfaces.

FIG. 5 illustrates an aspect of the present invention having the loading of the foamed butterfly door, with a peak in the force loading curve at both ends of travel.

FIG. 6 illustrates an aspect of the present invention having the loading of the magnetically sealed butterfly door, with the loading profile flattened out at the ends of travel with the magnetic sealing.

FIG. 7 illustrates flap sealings with magnetically impregnated (magnetic impregnated) plastic on the door.

FIG. 8 illustrates Santoprene type seal with a magnetically assisted door mechanism.

FIG. 9 illustrates an aspect of the present invention having a door and housing and cam or actuator element.

FIG. 10 illustrates an aspect of the present invention showing the method of maintaining or breaking the seal between the door and housing of the HVAC unit.

### DETAILED DESCRIPTION OF THE PREFERRED EMBODIMENT

In various aspects of the present invention, an HVAC unit for automotive vehicles is provided having: a housing; at least one air passage in the housing; a blower mechanism to draw or propel air through at least part of the housing and at least one door. In various aspects, the at least one door partially or fully opens to allow air passage through the at least one air passage in the housing, and the door, when closed, forms a seal at at least one area of contact with the housing.

The present invention, in various aspects, provides for a HVAC unit having at least one door and at least one part of an HVAC housing, such that the housing and door can approach one another and form a seal. Preferred embodiments of the present invention use a magnetically assisted (or resistant) door sealing mechanism to form a seal, or preferably, a tight seal, upon closure at a sealing area having a door sealing surface and a corresponding HVAC housing or other such surface, which blocks or restricts air flow in that area of the HVAC unit.

By using a magnetically assisted door sealing mechanism, and, especially a mechanism at a sealing surface and a corresponding surface, a seal, that is resistant to opening inappropriately when air flow or pressure increases or when influenced by gravity and, even an almost air tight seal, can be formed while still allowing for the door to be opened, with a minimum of effort, when necessary.

Various aspects of the present invention, doors of various strengths or stiffness (compliance levels or ‘compliant’ doors) can be used. By allowing for different forces, generally inferior to those used with non compliant (stiff doors) for example, the closure force, instead of being totally repulsive or resistant in form (for example foam compressing resists closure), utilizes a magnetic attractive force is used to assist in the final/last few millimeters or degrees of door closure. In preferred aspects of the present invention, magnetic repulsive force is present, where necessary or appropriate, to reduce the undesired ‘forced’ or ‘slammed’ closure due to gravity or inertial slamming. By reducing the door closing forces, the actuation power requirement, and acoustic power, is reduced, leading to a mechanical closing with less undesirable noise product (mechanically quieter closing). Also, in various aspects of the present invention, a compliant door with a magnet is provided

HVAC units, in accordance with various aspects of the present invention, have at least one sealing surface or corresponding surface that has a magnetically assisted door sealing mechanism. In various aspects of the present invention, the magnetically assisted door sealing mechanism has at least one area with a magnet. In other particular embodiments, the door sealing mechanism has more than one magnet. In further embodiments, the magnets cause micro undulations in the polarity across the sealing area by means of attraction or repulsion of magnetic forces. Also, in accordance with the present invention are aspects wherein the door sealing mechanism has more than one magnet and wherein the magnets cause micro undulations in the polarity across the sealing area by means of attraction and repulsion of magnetic forces.

Sealing areas that are found in aspects of the present invention can comprise a number of elements. In various aspects, the sealing area further has a foam or Santoprene element. A further aspect of the present invention has a part, such as door or housing, impregnated with a product, such as Santoprene (or similarly, another product also useful in what is normally referred to as an ‘over-molding’ concept) By over-molding, it is meant a secondary or additional molding typically composed of rubberized or other flexible material, over the primary substrate, for example a door, Particularly, a magnet component is positioned within the secondary material. The magnetic mechanism comprising magnetic material and product is then attracted to a magnetically impregnated sealing surface or face directly on the housing.

The tolerance of the doors and their sealing planes, correspondent surfaces and the edges of the magnetic seal, can use stiff or flexible doors. Preferably, at least one door is semi-rigid or rigid (‘stiff’) door(s). In various aspects of the present invention, magnetically affected surfaces are internally flexible. Magnetically affected surfaces on top of foam substrate, or impregnated within the foam or flexing rubber impregnated seals are present in various aspects of the present invention. Foam or rubber or rubberized or Santoprene elements, or the like, can also be found in the sealing area. In a more preferred aspect of the present invention, at least one door, and, preferably, at least two doors or a plurality of doors are provided, that are more compliant (deliberately flexible by a small amount but still geometrically stable from an airflow point of view). Door compliance or flexibility allows the door to take up or absorb the tolerance improprieties of the sealing area, and, specifically, affect the door sealing plane or corresponding surface interface rather than the magnetic seal itself. In a method of the present invention, the opening torque of the at least one door is dictated via the level of flexibility of the door itself, hence one end of the door would open temporally (in a time related fashion), before the other. The door could be perceived, visually, as being ‘peeled’ open. Conversely, the at least one door can also be ‘peeled’ shut. The present invention provides, by various methods, means, therefore, to overcome any undue initial magnetic lock out or spiked or peak forces that are required to open the door.

In various aspects of the present invention, the sealing area has a positive sealing between the door and its corresponding seal on the case and is relieved. By positive seal, it is meant a correctly functioning seal, e.g. positively sealed closed means properly sealed to achieve its desired function. In particular aspects wherein a positive sealing exists between the door and its sealing surface, it is relieved in its open position. For the present invention, it is understood that ‘relieved’ means, opening, undoing partially or completely a seal, relieving sealing aspects of the seal, unclosing, re-opening, or the like, or otherwise causing the positive seal to be relieved of its properly closed function or to be ‘opened.’ A positive seal, therefore, can be a relievable seal and relieved in a number of different manners. In other particular aspects of the present invention, the positive sealing or tight seal is relieved in a manner other than straight peeling or opening.

In preferred embodiments of the present invention, magnetically impregnated foam or rubber materials (‘products’) are provided. Base material has polarity undulations or reversals in the direction perpendicular to its extrusion axis of a spatial period of from between about, more typically from between about 1 to about 4 millimeters (mm). A seal may be formed, such that the seal can open slightly or be ‘cracked open’ via sliding or slipping the paired magnetic sealing surfaces across one another. In the ‘attracted’ position or ‘holding’ orientation, the north and south ridges in the base materials align and stay pulled together. In the ‘repulsive’ position or ‘releasing’ orientation (typically from between about 2 mm to between about 3 mm relative slip to/from the attracted position), the north/north and south/south poles become aligned and the resulting repulsion allows the base materials to separate easily or even forcefully, resulting finally in an opening at the area of the seal.

As describes above, in preferred aspects of the present invention, the natural polarity of undulations of the base or door ‘plastic’ material is in the order of between about 0.01 mm and 50 mm periodicity. The undulations are ‘magnetic fixed waves’ in the base magnetic field. The magnetic field has undulations from north to south that are manufactured into it. These manifest themselves as fixed magnetic waves, or waves containing magnetism. By sliding the door and corresponding surfaces relative to one another, the so called south/north attraction is replaced with south/south and north/north repulsion due to the spatial location of the magnetically affected materials (or elements). A cam or mechanical advantage or lever system/ mechanism, works over the few millimeters of polarity undulation, and the tight seal formed at the sealing area can be made to break open naturally by utilizing unusual or normally unused properties of repulsion of the magnetic fields.

The following two dipole layouts attract one another:—

NSNSNSNSN

SNSNSNSNN

After physical displacement of the part by one half a magnetic period, the following same parts repel:—

NSNSNSNSN
SNSNSNSNS→

This small movement allows the seals to separate due to repulsion.

A door useful for making a tight seal can be non rigid or, preferably, stiff or rigid or non compliant. By magnetic seal is meant an area wherein at least part of the seal is formed and/or maintained due to magnetic forces—it can include, therefore, a full or partial magnetic seal. The magnetic seal (or door surface with magnetic materials or corresponding surface with magnetic materials or elements) is, preferably, of a compliant nature or non rigid nature, in various aspects.

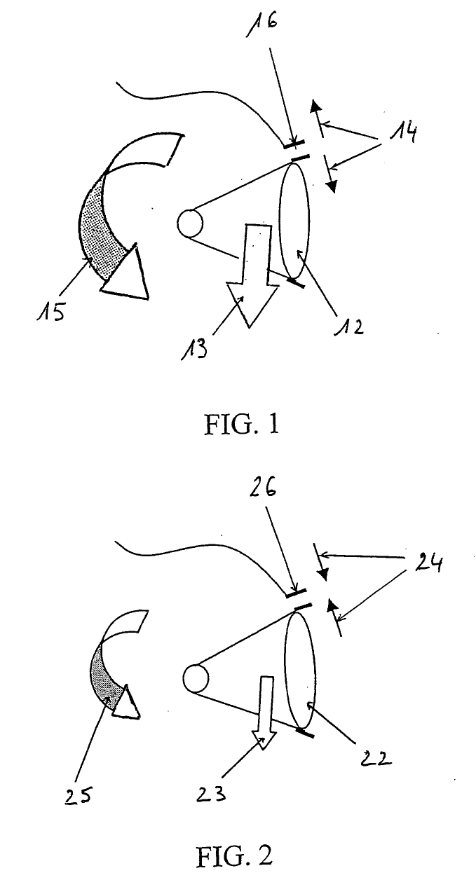

Referring to FIG. 1 is shown a typical barrel type door (12) and the gravitational torque (13) compounded with the repulsive action (14) in the seal due to the compression of the foam seal (16) itself. Thus the resultant reaction torque (15) to hold or position the door in the sealing position is high.

Referring to FIG. 2 is shown a typical barrel type door (22) and the gravitational torque (23) somewhat being overcome or assisted in the sealing action due to the magnetic action of the seals (24) in the near or intra sealing position (25). The final closing and or holding reaction torque on the actuation mechanism (25) is reduced or nullified.

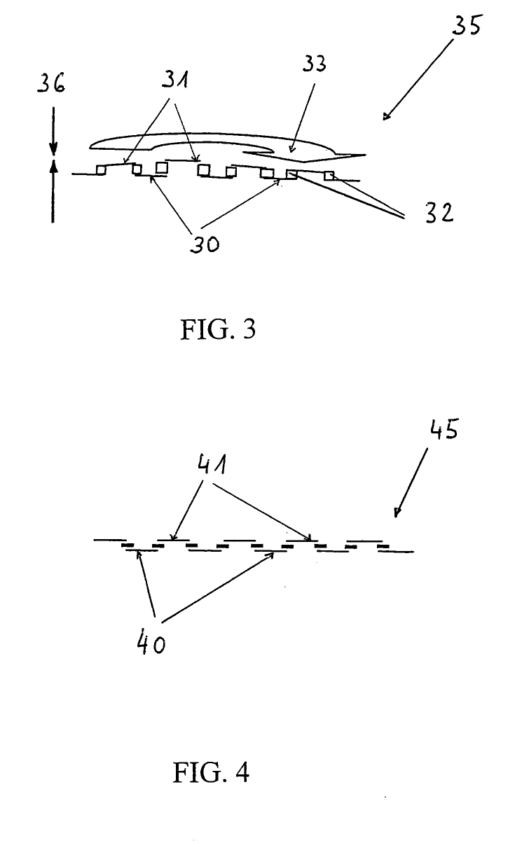

Referring to FIG. 3 is shown schematically one pair of sealing surfaces (30, 31) in a typical louver type door (35). The reaction force increases rapidly with the shallow or small travel of the door (36), the foam (32) compression or repulsive force tends to distort the wide expanse of the louver door (33). Sealing is difficult, if not an impossibility, for such a system.

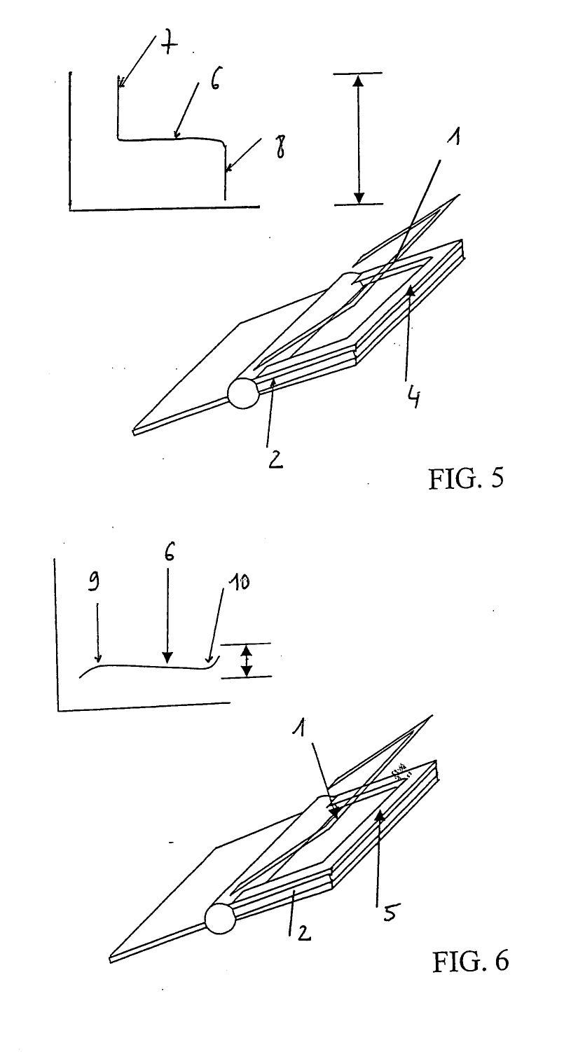

Referring to FIG. 4 is shown schematically one pair of sealing surfaces (40, 41) in a typical louver type door (45). The doors or louvers (40, 41) are capable of magnetic sealing to one another eliminating or reversing the effect experienced with the foam or rubber type seal. The reaction forces now assist in the closure of the louvers to one another, without apparent distortion or leakage.

Referring to FIG. 5 is shown schematically one sealing plane (1) of one side of a typical butterfly type door (2), also, but not illustrated here, in a flag type door. The reaction force/torque curve (3) shows the generally flat gravitational (6)or frictional component spread between the two end points which are made known by the strong reaction upward (7) and downward spikes(8) due to the foam (4) compression.

Referring to FIG. 6, is shown schematically the possible reduction (9,10) or even reversal of the reaction forces, made feasible by careful use of magnetic sealing to replace the normal foam compression (4,7,8). The magnetic seal closes the door.

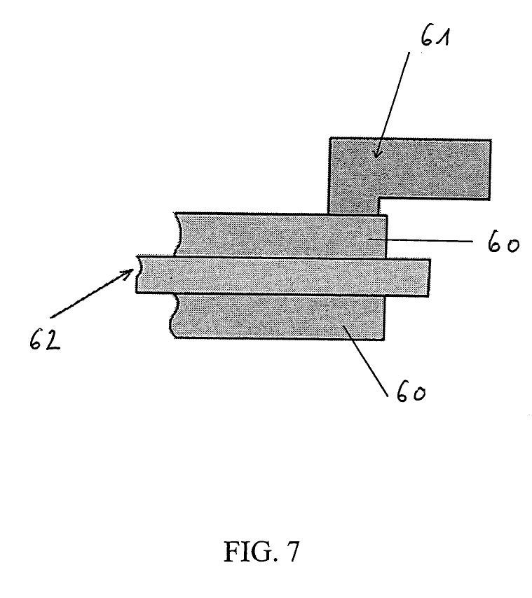

Referring to FIG. 7, is shown a method to replace the foam sealing on the doors directly with magnetic impregnated plastic (60). The impregnated plastics stuck or bonded onto the sealing surface(s) or corresponding surface(s) on the housing (61). The doors (62) will then be attracted into sealing (60, 62) and therefore closing at either ends of the travel, rather than requiring a further compressive force or torque.

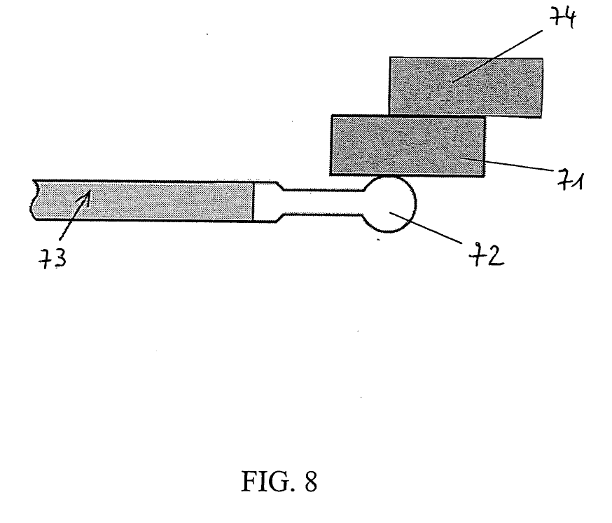

Referring to FIG. 8, is shown an approaching Santoprene type seal (72) with an interface (71) of large surface area. A magnetically assisted door mechanism with (71, 72) with attractive features which forms a tight seal between the door (73) and the casing or housing (74).

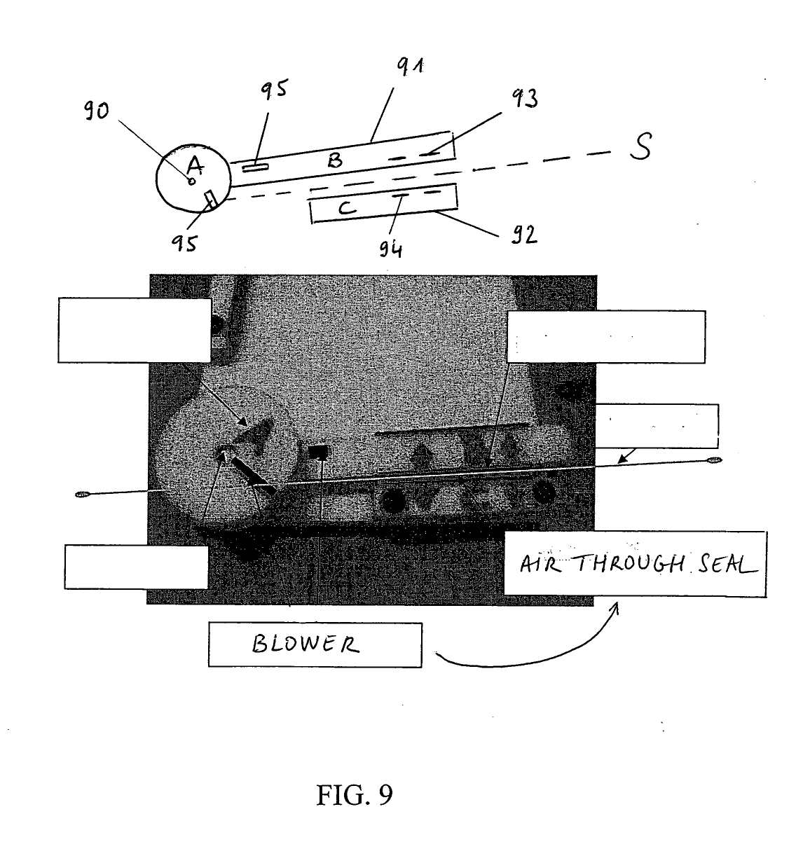

Referring to FIG. 9 is shown a mock up of an HVAC unit with the blower (not shown) to propel, push or pull, air and door (B) (91) having a magnet or magnetic element (93) in the door or magnet or magnetic element (94) in the housing (92) or both. A sealing plane (S) is illustrated where contact may occur in a sealing area between the door (91) and housing (92) or elements attached to or incorporated into the door and/or housing (not shown). Cam (A) with cam axis (90) and cam alignment marks (95) for illustration, are shown. (B) and (C) represent the main sections of the door that can be pulled apart from or peeled apart from one another at the area of the sealing area or sealing plane to open the door from the housing in the open position or close or seal the door and the housing in the closed position.

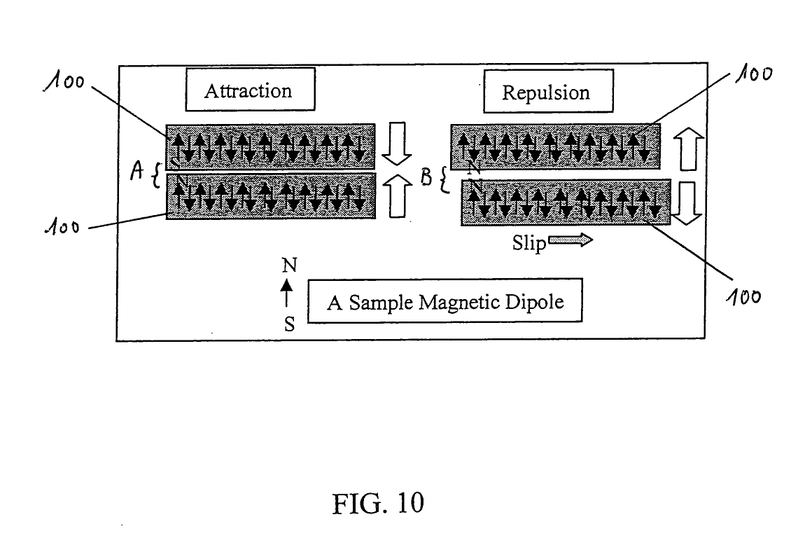

Referring to FIG. 10 is shown attraction and repulsion forces on the door and/or housing (100, 110) capable of being closed to form a seal or opened or peeled to break a seal at areas A and B respectively.

The magnetic force or strength profile could be setup or designed or adjusted to suit by using a physically tapered magnetic strip. Thus the initiation of opening can be ‘weakened’ to further improve the actuation torque or force profile.

Furthermore, the strength of the magnetic field can be weakened by deliberately misaligning the magnetic strips or seals, such that they will allow peel opening and peel closing where appropriate.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. An HVAC unit for automotive vehicles having:
a housing;
at least one air passage in the housing;
a blower mechanism to propel, draw or push air through at least part of the housing;
at least one door;
wherein the at least one door partially or fully opens to allow air passage through the at least one air passage in the housing, and wherein the door, when closed, forms a seal at at least one area of contact with the housing.

2. An HVAC unit as in claim 1, wherein the HVAC unit has a sealing area around a sealing plane, the door has a sealing surface, and the housing has a corresponding surface.

3. An HVAC unit as in claim 1 wherein the HVAC unit has a sealing area around a sealing plane the housing has a sealing surface and the door has a corresponding surface.

4. An HVAC unit as in claims 2, wherein either the sealing surface or the corresponding surface has a magnetically assisted door sealing mechanism.

5. An HVAC unit as in claim 3, wherein the door is compliant.

6. An HVAC unit as in claim 4, wherein the door is compliant.

7. An HVAC unit as in claim 6, wherein the sealing area further has a foam or rubber or rubberized or Santoprene element, or the like.

8. An HVAC unit as in claim 4, wherein the magnetically assisted door sealing mechanism has at least one area with a magnet.

9. An HVAC unit as in claim 8, wherein the door sealing mechanism has more than one magnet and wherein the magnets cause micro undulations in the polarity across the sealing area by means of attraction or repulsion of magnetic forces.

10. An HVAC unit as in claim 8, wherein the door sealing mechanism has more than one magnet and wherein the magnets cause micro undulations in the polarity across the sealing area by means of attraction and repulsion of magnetic forces.

11. An HVAC unit as in claim 9, wherein a relievable positive sealing exists between the door and its corresponding seal on the housing.

12. An HVAC unit as in claim 10, wherein a relievable positive sealing exists between the door and its sealing surface.

13. An HVAC unit as in claim 11, wherein the positive sealing is relieved in a manner other than straight peeling or opening.

14. An HVAC unit as in claim 12, wherein the positive sealing is relieved in a manner other than straight peeling or opening.

15. An HVAC unit as in claim 5, wherein either the sealing surface or the corresponding surface has a magnetically assisted door sealing mechanism.
